(19) United States
(12) Patent Application Publication
(10) Pub. No.: US 2012/0123898 A1
(43) Pub. Date: May 17, 2012

(54) GENERATING CONFIGURATION OPTIONS FOR A COMPUTING SYSTEM

(75) Inventors: Kevin W. Kirkeby, Rochester, MN (US); Richard M. Smith, Oronoco, MN (US)

(73) Assignee: INTERNATIONAL BUSINESS MACHINES CORPORATION, Armonk, NY (US)

(21) Appl. No.: 12/947,964

(22) Filed: Nov. 17, 2010

(51) Int. Cl. G06F 15/177; G06Q 30/00

(52) U.S. Cl. 705/26.7; 709/220

(57) ABSTRACT

A computer-implemented method includes receiving, at a configuration server, requirements data identifying computing requirements of a customer. The computer-implemented method includes receiving, at the configuration server, inventory information descriptive of a computing inventory of the customer. The computer-implemented method also includes accessing compatibility rules that specify hardware and software to enable particular computing requirements. The computer-implemented method further includes determining a plurality of configuration options to implement the computing requirements of the customer based on at least one of the requirements data, the computing inventory, and the compatibility rules. The plurality of configuration options include at least one customer premises equipment (CPE)-based configuration, at least one cloud computing-based configuration, and at least one hybrid CPE-cloud computing-based configuration. The computer-implemented method includes comparing the plurality of configuration options based on customer preferences. The computer-implemented method also includes providing at least one configuration recommendation based on comparing the plurality of configuration options.

### I. FIELD OF THE DISCLOSURE

The present disclosure relates generally to generating configuration options for a computing system.

### II. BACKGROUND

A customer may desire to deploy a particular software solution. Many customer considerations are evaluated when configuring a computing system to support a software solution. For example, a customer may request a price quotation for deploying the particular software solution. Determining a price quotation for the computing solution may include determining prerequisites, such as hardware prerequisites and software prerequisites for the computing solution. Determining a price quotation for the computing solution may include determining recommendations based on the customer's preferences. For example, the customer may have a preference that the computing solution be deployed within a particular time frame or for a particular initial cost. Thus, determining a price quotation that takes into account the customer's current computing inventory, prerequisites, and preferences may be time-consuming and error prone.

### III. SUMMARY

In a particular embodiment, a computer-implemented method includes receiving, at a configuration server, requirements data identifying computing requirements of a customer. The computer-implemented method includes receiving, at the configuration server, inventory information descriptive of a computing inventory of the customer. The computer-implemented method also includes accessing compatibility rules that specify hardware and software to enable particular computing requirements. The computer-implemented method further includes generating a plurality of configuration options to implement the computing requirements of the customer based on at least one of the requirements data, the computing inventory, and the compatibility rules. The plurality of configuration options including at least one customer premises equipment (CPE)-based configuration, at least one cloud computing-based configuration, and at least one hybrid CPE-cloud computing-based configuration. The computer-implemented method includes comparing the plurality of configuration options based on customer preferences. The computer-implemented method also includes providing at least one configuration recommendation based on comparing the plurality of configuration options.

In another particular embodiment, a computer program product includes a non-transitory computer usable medium having computer usable program code embodied therewith. The computer usable program code is executable by a processor to receive requirements data identifying computing requirements of a customer. The computer usable program code is executable by the processor to receive inventory information descriptive of a computing inventory of the customer. The computer usable program code is further executable by the processor to access compatibility rules that specify hardware and software to enable particular computing requirements. The computer usable program code is further executable by the processor to determine a plurality of configuration options to implement the computing requirements of the customer based on at least one of the requirements data, the computing inventory, and the compatibility rules. The plurality of configuration options including at least one customer premises equipment (CPE)-based configuration, at least one cloud computing-based configuration, and at least one hybrid CPE-cloud computing-based configuration. The computer usable program code is executable by the processor to compare the plurality of configuration options based on customer preferences. The computer usable program code is further executable by the processor to provide at least one configuration recommendation based on comparing the plurality of configuration options.

In another particular embodiment, a configuration server includes a processor and a non-transitory memory having computer usable program code embodied therewith. The computer usable program code is executable by the processor to receive requirements data identifying computing requirements of a customer. The computer usable program code is executable by the processor to receive inventory information descriptive of a computing inventory of the customer. The computer usable program code is further executable by the processor to access compatibility rules that specify hardware and software to enable particular computing requirements. The computer usable program code is executable by the processor to determine a plurality of configuration options to implement the computing requirements of the customer based on at least one of the requirements data, the computing inventory, and the compatibility rules. The plurality of configuration options include at least one customer premises equipment (CPE)-based configuration, at least one cloud computing-based configuration, and at least one hybrid CPE-cloud computing-based configuration. The computer usable program code is executable by the processor to compare the plurality of configuration options based on customer preferences. The computer usable program code is further executable by the processor to provide at least one configuration recommendation based on comparing the plurality of configuration options.

These and other advantages and features that characterize embodiments of the disclosure are set forth in the claims listed below. However, for a better understanding of the disclosure, and of the advantages and objectives attained through its use, reference should be made to the drawings and to the accompanying descriptive matter in which there are described exemplary embodiments of the disclosure.

### IV. BRIEF DESCRIPTION OF THE DRAWINGS

FIG. 1 is a block diagram of an embodiment of a system to generate configuration options;

FIG. 2 is a block diagram of an embodiment of a customer inventory data record;

FIG. 3 is a flow diagram of a first method to generate configuration options;

FIG. 4 is a flow diagram of a second method to generate configuration options;

FIG. 5 is a flow diagram of a third method to generate configuration options;

FIG. 6 is a flow diagram of a fourth method to generate configuration options;

FIG. 7 is a flow diagram of a fifth method to generate configuration options;

FIG. 8 is a block diagram of a first embodiment of a graphical user interface to generate configuration options;

FIG. 9 is a block diagram of a second embodiment of a graphical user interface to generate configuration options; and

FIG. 10 is a block diagram of a third embodiment of a graphical user interface to generate configuration options.

### V. DETAILED DESCRIPTION

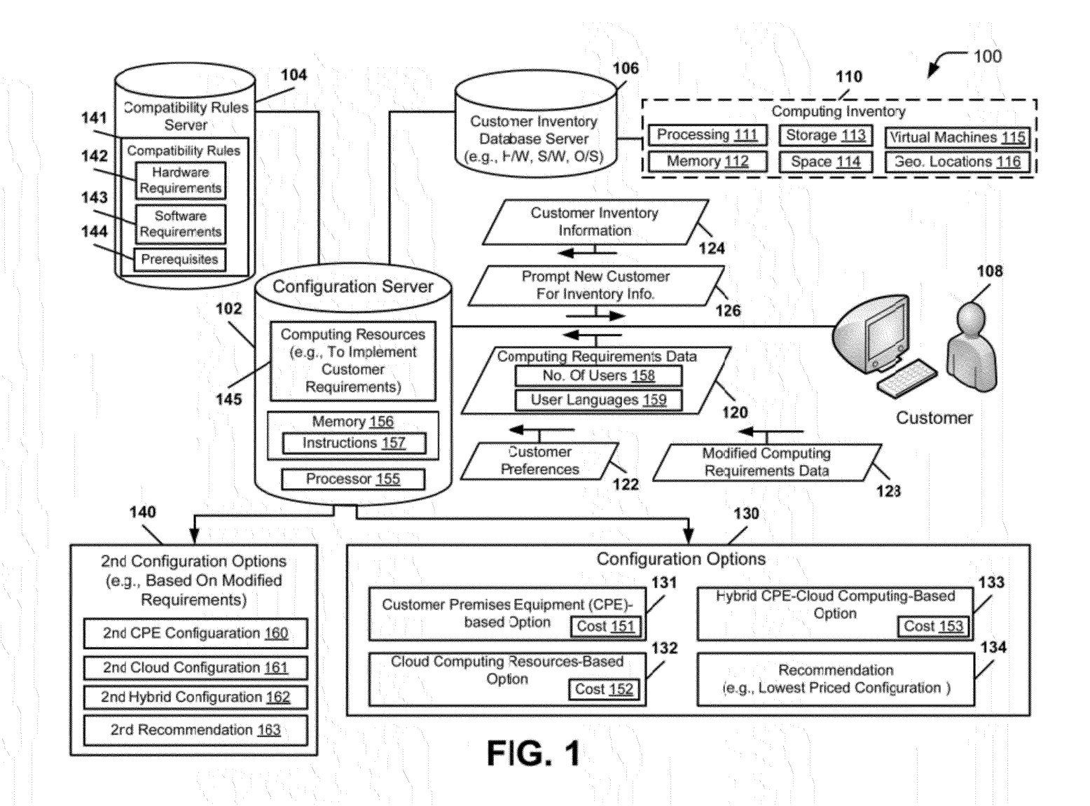

Referring to FIG. 1, a block diagram of an embodiment of a system to generate configuration options is depicted and generally designated 100. The system 100 includes a configuration server 102 coupled to a compatibility rules server 104 and to a customer inventory database server 106. The system 100 is capable of generating configuration options to enable a customer 108 to deploy a particular software solution. A software solution may be one or more software applications that are configured to perform one or more function. For example, a software solution may provide point-of-sale functionality, inventory management functionality, call center functionality, patient scheduling and billing functionality, another type of functionality, or any combination thereof.

The configuration server 102 is capable of receiving computing requirements data 120 that identifies computing requirements of the customer 108, determining computing resources 145 associated with implementing the computing requirements of the customer 108, and generating configuration options 130 based on the computing requirements. The configuration options 130 include one or more options, such as the options 131, 132, 133, and 134. The options 131-134 are provided for illustration purposes and are not intended to limit the number of options generated by the configuration server 102. The options 131-134 may include new configurations, modifications to a current configuration, or any combination thereof. The configuration server 102 includes a processor 155 and a memory 156. The memory 156 includes instructions 157 that are executable by the processor 155 to perform various functions of the configuration server 102, such as determining the computing resources 145 and generating the configuration options 130 based on the computing requirements data 120.

The compatibility rules server 104 includes rules associated with compatibility for multiple software solutions. For example, specific hardware requirements 142, software requirements 143, and prerequisites 144 may be associated with each software solution. When a customer 108 indicates interest in deploying a software solution, the configuration server 102 may access the compatibility rules server 104 to determine the compatibility of the software solution with a current customer computing inventory 110. The configuration server 102 may determine the computing resources 145, i.e., additional hardware and/or software components that are to be installed to enable the software solution to be deployed.

The customer inventory database server 106 includes the computing inventory 110 associated with the customer 108. The computing inventory 110 may include one or more of a processing inventory 111, a memory inventory 112, a storage inventory 113, a space inventory 114, a virtual machine inventory 115, a geographic location inventory 116, additional computing inventory-related data, or any combination thereof. The processing inventory 111 may include one or more of a number of processors, a number of cores, other processor related information related to the computing inventory 110, or any combination thereof. The processing inventory 111 may include one or more of a total available processing capacity, a currently utilized processing capacity, an available processing capacity, another type of processing capacity of the computing inventory 110, or any combination thereof. The memory inventory 112 may identify one or more of a total memory capacity, a currently utilized memory capacity, an available memory capacity, another memory capacity of the computing inventory 110, or any combination thereof. The storage inventory 113 may include a total storage capacity, a currently utilized storage capacity, an available storage capacity, another type of storage capacity of the computing inventory 110, or any combination thereof.

The geographic locations 116 may include data identifying geographic locations where portions of the computing inventory 110 are located. The geographic locations 116 may enable the configuration server 102 to determine user languages that are commonly in use in a particular geographic location, a best fit based on connectivity/network response, import/export restrictions for each of the geographic locations 116, and other geographically-related information. For example, a first customer location may not have space to deploy an additional server. The configuration server 102 may use the geographic locations 116 to identify a second customer location that has space to deploy the additional server and is geographically situated at a distance from the first customer location that enables the configuration to satisfy specific network response criteria. As another example, the configuration server 102 may determine that one of the hardware requirements 142 of a particular software solution may not be exported to one of the geographic locations 116. In this situation, the configuration server 102 may provide a recommendation 134 that provides the hardware requirements 142 via a cloud computing-based configuration rather than a customer premises equipment (CPE)-based configuration. In cloud computing, a cloud computing provider may create virtual partitions computing resources (e.g., computing hardware and computing software) and make a particular virtual partition available to a customer for a monthly fee. The customer may access the particular virtual partition via a network, such as the Internet. The customer does not worry about installing, maintaining, and upgrading the computing resources because the cloud computing provider installs, maintains, and upgrades the computing resources at the premises of the cloud computing provider. The cloud computing resources may be dynamically scalable to provide “on demand” computing resources.

The space inventory 114 may indicate the physical space available for deploying a particular hardware solution. The space inventory 114 may include the total amount of physical space available, a currently utilized amount of physical space, and an available amount of physical space at each of the geographic locations 116. For example, the space inventory 114 may indicate how much physical space is available to deploy additional rack units at each geographic location. The virtual machine inventory 115 may include information associated with the virtual machines in the computing inventory 110. For example, the virtual machines inventory 115 may include a total number of virtual machines, a currently utilized number of virtual machines, and an available number of virtual machines of the computing inventory 110.

In operation, the configuration 102 may receive computing requirements data 120 identifying computing requirements of the customer 108. The computing requirements data 120 may include a number of users 158 and a user language 159. The computing requirements data 120 may also include additional computing requirements (not shown), such as security requirements (e.g., physical security, network security, access-level security, etc.), connectivity requirements (e.g., the customer may desire to deploy a standalone network that is not connected to the internet), configuration requirements (e.g., the customer does not want a cloud computing-based configuration, does not want a hybrid configuration, does not want a CPE-based configuration), etc. The number of users 158 may identify user-related utilization characteristics. For example, the number of users 158 may identify a maximum number of users that the customer 108 estimates will use the software solution at any given time. The number of users 158 may indicate an average number of users that the customer 108 estimates will use the software solution. The user languages 159 may identify one or more languages (e.g., French, Spanish, German) to enable the configuration server 102 to identify software solutions that are capable of providing a user interface in those languages. In a particular embodiment, the configuration server may select the configuration options 130 based on the user languages 159 and the geographic locations 116. For example, the customer 108 may indicate a desire for the user languages 159. The configuration server 102 may determine that additional languages are spoken in a particular geographic area where the computing solution is to be deployed. The configuration server 102 may generate the configuration options 130 and provide reasons for generating each of the configuration options 130. For example, one of the reasons may explain that the user languages 159 specified English and French and that the geographic locations 116 indicated that Italian and German were also common user languages in a particular geographic location (e.g., Switzerland). As another example, the configuration server 102 may identify that first geographic location of the customer 108 has a first user language (e.g., English in England) and identify that a second geographic location has a second user language (e.g., French in France).

The configuration server 102 may receive customer inventory information 124 descriptive of a computing inventory of the customer 108. When the customer 108 is a new customer, the configuration server 102 may prompt the customer 108 to provide information associated with the customer inventory and store the customer inventory information 124 in the customer inventory database server 106. When the customer 108 is not a new customer, the configuration server 102 may request and receive the customer inventory information 124 from the customer inventory database server 106.

The configuration server 102 may access the compatibility rules server 104 to identify the hardware requirements 142, the software requirements 143, and the prerequisites 144 of the computing requirements data 120. The configuration server 102 may identify the computing resources 145 that may be used to implement the computing requirements identified by the computing requirements data 120. The configuration server 102 may generate configuration options 130 to implement the computing requirements data 120 of the customer 108 based on at least one of the computing requirements data 120, the customer inventory information 124, the hardware requirements 142, the software requirements 143, and the prerequisites 144. The configuration options 130 may include at least one CPE-based configuration 132, at least one cloud computing-based configuration 132, and at least one hybrid CPE-cloud computing-based configuration 133. The configuration server 102 may compare the plurality of configuration options based on customer preferences 122 received from the customer 108. For example, the customer preferences 122 may indicate that the customer 108 prefers a configuration option with the lowest total costs, with the lowest initial costs, with the lowest ongoing costs, with the fastest time to deploy, and with the best performance. The configuration server 102 may provide at least one recommendation 134 after comparing the configuration options 130 based on the customer preferences 122. For example, the configuration server 102 may determine a cost associated with each of the configurations 131-133 and provide the recommendation 134 based on the lowest cost configuration of the configurations 131-133.

After reviewing the configuration options 130, the customer 108 may provide modified computing requirements data 128 identifying modified computing requirements to the configuration server 102. The configuration server 102 may determine second configuration options 140 to implement the modified computing data requirements 128 based on the customer inventory information 124 and the compatibility rules 141. The second configuration options 140 may include a second CPE-based configuration 160, a second cloud computing-based configuration 161, and a second hybrid CPE-cloud computing based configuration 162. The configuration server 102 may determine a second recommendation 163 after comparing the configuration options 160-162 based on the customer preferences 122. This process may be repeated to generate additional configuration options. For example, the customer 108 may again modify the computing requirements data 128 to enable the configuration server 102 to generate additional configuration options (not shown), such as third configuration options, fourth configuration options, etc.

Thus, the configuration server 102 can automatically generate the configuration options 130 based on one or more of the computing requirements data 120, the customer inventory information 124, and the customer preferences 122. The configuration server 102 can compare the configuration options 130 and identify the recommendation 134. The configuration options 130 enable the customer 108 to compare the configuration options 130 based on different factors, such as the costs 151-153 associated with the respective configuration options 131-133. In this way, the customer 108 can purchase and deploy a particular configuration of the configuration options 130 that most closely meets the customer preferences 122.

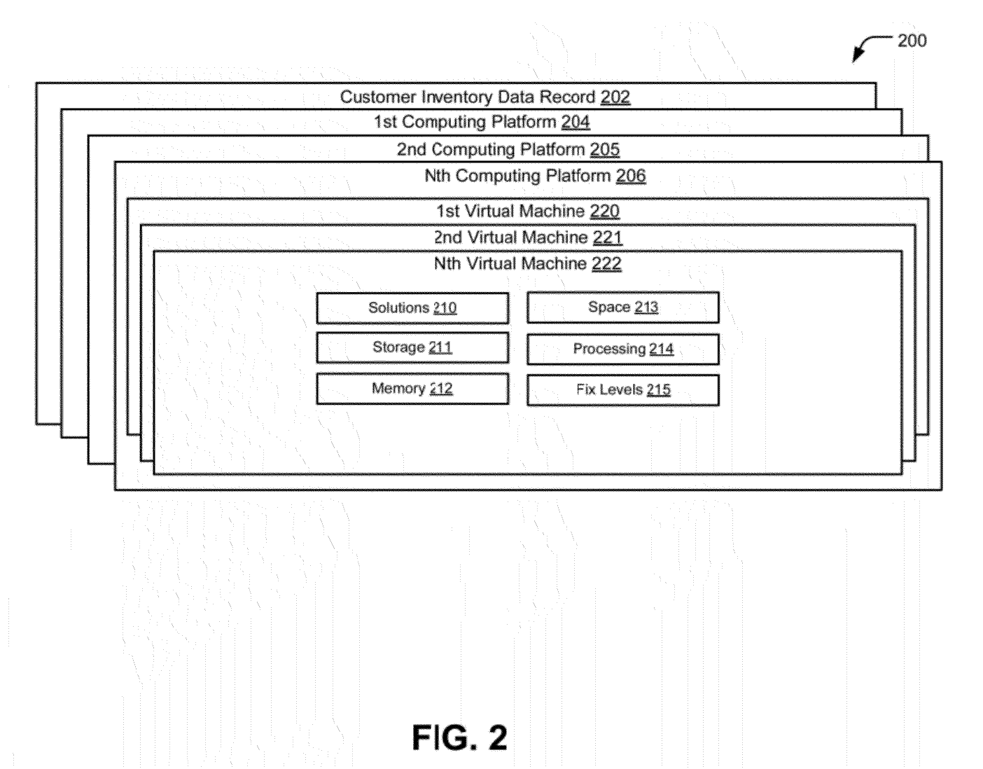

Referring to FIG. 2, a block diagram of an embodiment of a customer inventory data record is depicted and generally designated 200. The customer inventory data record 200 may be stored at the customer inventory database server 106 of FIG. 1.

The customer inventory data record includes a customer inventory data record 202. The customer inventory data record 202 may include one or more computing platforms that are available (i.e., leased, owned, or a combination thereof) to the customer. For example, the customer inventory data record 202 may include a first computing platform 204, a second computing platform 205, and additional computing platforms up to an Nth computing platform 205, where N is greater than 2.

Each of the computing platforms 204-206 may include a combination of computing hardware and software. The customer inventory data record 202 may include information associated with each of the computing platforms 204-206, such as virtual machines associated with each of the computing platforms 204-206. For example, the Nth platform 206 may execute a first virtual machine 220, a second virtual machine 221, and additional virtual machines, including an Nth virtual machine 222, where N is greater then 2. The customer inventory data record 202 may include information associated with each of the virtual machines 220-222, such as solutions 210, storage 211, memory 212, space 213, processing 214, and fix levels 215.

The solutions 210 may identify software solutions currently running on the Nth virtual machine 222, such as a word processing suite software solution, a point-of-sale software solution, and an inventory database software solution. The storage 211 may identify the storage capabilities of the Nth virtual machine 222. For example, the storage 211 may identify a total storage capacity of the Nth virtual machine 222, a currently utilized storage capacity of the Nth virtual machine 222, and an available storage capacity of the Nth virtual machine 222. The memory 212 may identify a total memory capacity of the Nth virtual machine 222, a currently utilized memory capacity of the Nth virtual machine 222, and an available memory capacity of the Nth virtual machine 222. The space 213 may identify physical space associated with the underlying hardware resources assigned to the Nth virtual machine 222. For example, the space 213 may indicate that the computing hardware associated with the Nth virtual machine 222 has a rack with two available rack spaces. The processing 214 may indicate a total processing capacity of the Nth virtual machine 222, a currently utilized processing capacity of the Nth virtual machine 222, and an available processing capacity of the Nth virtual machine 222. The fix levels 215 may identify a level of software fixes that have been installed at the Nth virtual machine 222.

Thus, the customer inventory data record 202 may identify information, such as the virtual machines 220-222, that are associated with the computing platforms 204-206 of a particular customer. The configuration server 102 of FIG. 1 may use the information provided by the customer inventory data record 202 to determine the computing resources 145 and to generate N configuration options (N>2), such as the configuration options 130, the second configuration options 140, and additional configuration options (now shown).

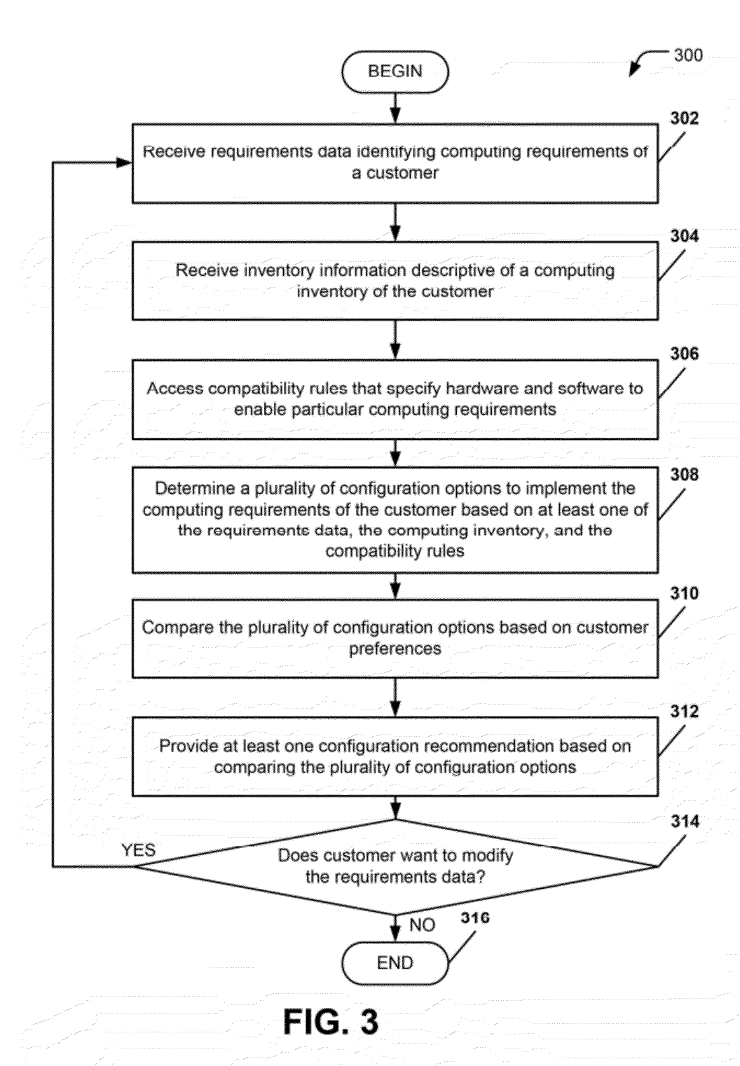

Referring to FIG. 3, a flow diagram of a first method to generate configuration options is depicted and generally designated 300. The method 300 may be performed by a configuration server, such as the configuration server 102 of FIG. 1.

The method 300 begins when the configuration server receives requirements data identifying computing requirements of the customer, at 302. Moving to 304, the configuration server may receive inventory information descriptive of a computing inventory of the customer. For example, in FIG. 1, the configuration server 102 may receive the computing requirements data 120 identifying computing requirements of the customer 108 and receive the customer inventory information 124. When the customer is a new customer, the customer may be prompted to provide the customer inventory information. When the customer is not a new customer the customer inventory information may be retrieved from a customer inventory database server. For example, in FIG. 1, when the customer 108 is not a new customer, the configuration server 102 may retrieve the computing inventory 110 associated with the customer 108 from the customer inventory database server 106. When the customer 108 is a new customer, the configuration server 102 may prompt the customer 108 to provide the customer inventory information 124.

Advancing to 306, the configuration server may access compatibility rules that specify hardware and software to enable particular computing requirements. For example, in FIG. 1, the configuration server 102 may access compatibility rules stored at the compatibility rules server 104. Proceeding to 308, the configuration server may determine a plurality of configuration options to implement the computing room requirements of the customer based on at least one of the requirements data, the computing inventory, and the compatibility rules. For example, in FIG. 1, the configuration server 102 may determine the configuration options 130 based on one or more of the computing requirements data 120, the current computing inventory 110, and the compatibility rules 141.

Advancing to 310, the configuration server may compare the compatibility of the configuration options based on customer preferences. For example, the customer preferences may indicate that the customer prefers not to deploy any additional hardware at the customer premises and prefers a lower initial cost configuration. Based on comparing the plurality of configuration options, the configuration server may provide at least one configuration recommendation that does not result in the customer deploying additional hardware at the customer premises at the lowest initial cost. For example, in FIG. 1, the configuration server 102 may compare the options 131-133 and provide the recommendation 134.

Advancing to 314, a determination may be made whether the customer desires to modify the requirements data. When the customer desires to modify the requirements data at 314, the method may proceed to 302 to receive modified requirements data of the customer. For example, after seeing the configuration options and the recommendation, the customer may desire to vary the requirements data to determine what effect the modified requirements data has on the available configuration options and the recommendation. When the customer does not desire to modify the requirements data, the method may end, at 316.

Thus, a configuration server may automatically generate configuration options based on computing requirements data, customer inventory information, and customer preferences. The configuration server may automatically compare the configuration options to identify a recommended configuration option. In this way, the configuration server can provide a recommended configuration option that satisfies the requirements of the customer and most closely meets the preferences of the customer.

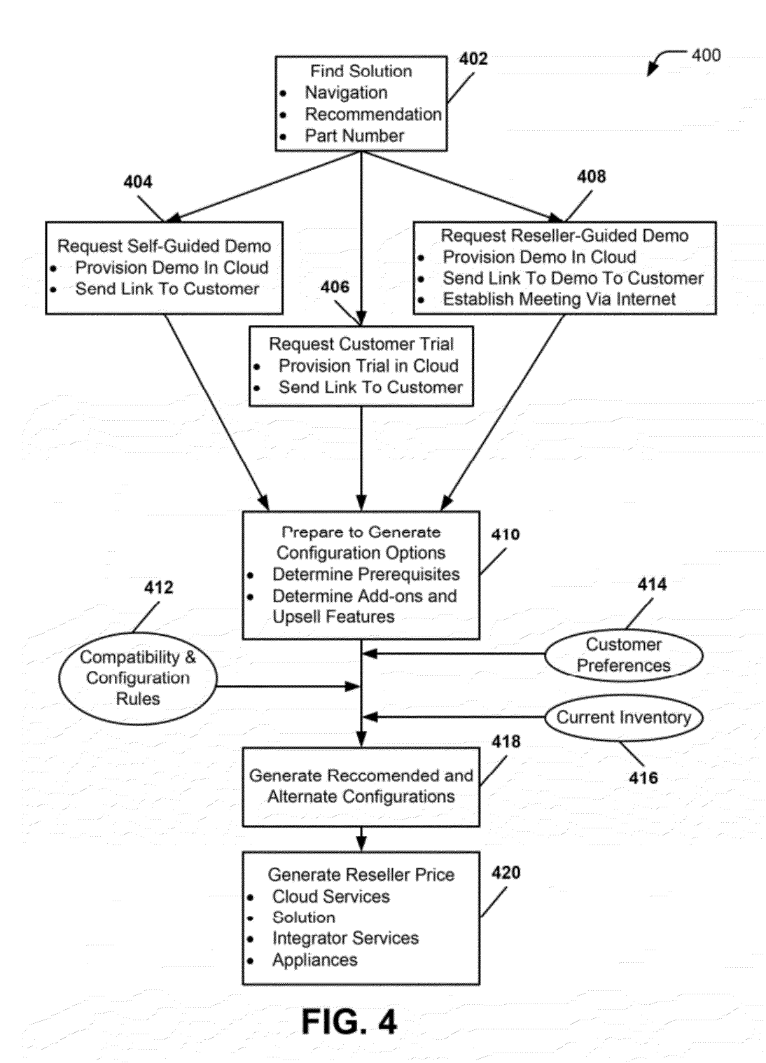

Referring to FIG. 4, a flow diagram of a second method to generate configuration options is depicted and generally designated 400. The method 400 may be performed by a configuration server, such as the configuration server 102 of FIG. 1.

The method 400 begins at 402 when a customer finds a solution (e.g., a software solution). For example, a customer may navigate a web-based tool to identify a particular solution. A reseller may recommend the solution to the customer. A sales representative may recommend a part number associated with the solution to the customer.

From 402, the method may proceed to 404, where a request for a self-guided demo may be received. For example, a customer who desires to view a demonstration of the solution may send a request for the self-guided demo via a web-based tool. In response to receiving the request, the configuration server 102 may provision a demo in a cloud computing environment and send a link to the customer to enable the customer to view the demo in the cloud computing environment.

From 402, the method may proceed to 406, where the customer may send a request for a customer trial. In response to receiving a request for the customer trial, the configuration server may provision a trial using cloud computing resources and send a link to the trial to the customer to enable the customer to perform the trial.

From 402, the method may proceed to 408, where a request for a reseller guided demonstration may be received. For example, the configuration server 102 of FIG. 1 a customer may send a request to the configuration server requesting that a reseller provide a guided demonstration to the customer. In response, the configuration server 102 may provision a demonstration using cloud computing resources, and send a link to the demonstration to the customer. The configuration server 102 may establish a teleconference or video conference via a network, such as the Internet, to enable the reseller to guide the customer through the provisioned demonstration.

From 404, 406, and 408, the method proceeds to 410, where preparations are made to generate configuration options. The configuration options may be generated based on determining prerequisites associated with the solution. For example, the solution requested by the customer at 402 may require additional hardware and/or software to be installed before the solution can be installed. The solution may also include add-ons and up-selling. For example, the generated solution may include add-ons to facilitate faster processing and/or additional user capacity. In preparation to generate the configuration options, compatibility and configuration rules may be retrieved, at 412. Customer preferences, such as a preference to locate hardware at a particular geographic location, may be received at 414. In preparation to generate the configuration options, a current inventory of the customer may determined at 416. When the customer is a new customer, the customer may be prompted to provide a current customer inventory. When the customer is not a new customer, the current customer inventory may be retrieved from a server, such as the customer inventory database server 106 of FIG. 1.

Moving to 418, recommended and alternate configurations may be generated based on the compatibility and configurations rules 412, the customer preferences 414, and the current inventory 416. For example, in FIG. 1, the configuration server 102 may generate the configuration options 130 and the recommendation 134. The recommended and alternate configurations may include one or more of a CPE-based configuration, a cloud computing configuration, and a hybrid CPE-cloud configuration.

Moving to 420, the configuration server may generate a reseller price when the customer intends to purchase one of the configuration options via a reseller, and the method ends.

Thus, a configuration server may automatically generate configuration options based on compatibility and configuration rules, customer inventory information, and customer preferences. The configuration server may automatically compare the configuration options to identify configuration options that include one or more of a CPE-based configuration, a cloud computing configuration, and a hybrid SPE-cloud computing configuration. The configuration server may provide a recommended configuration option and an associated price.

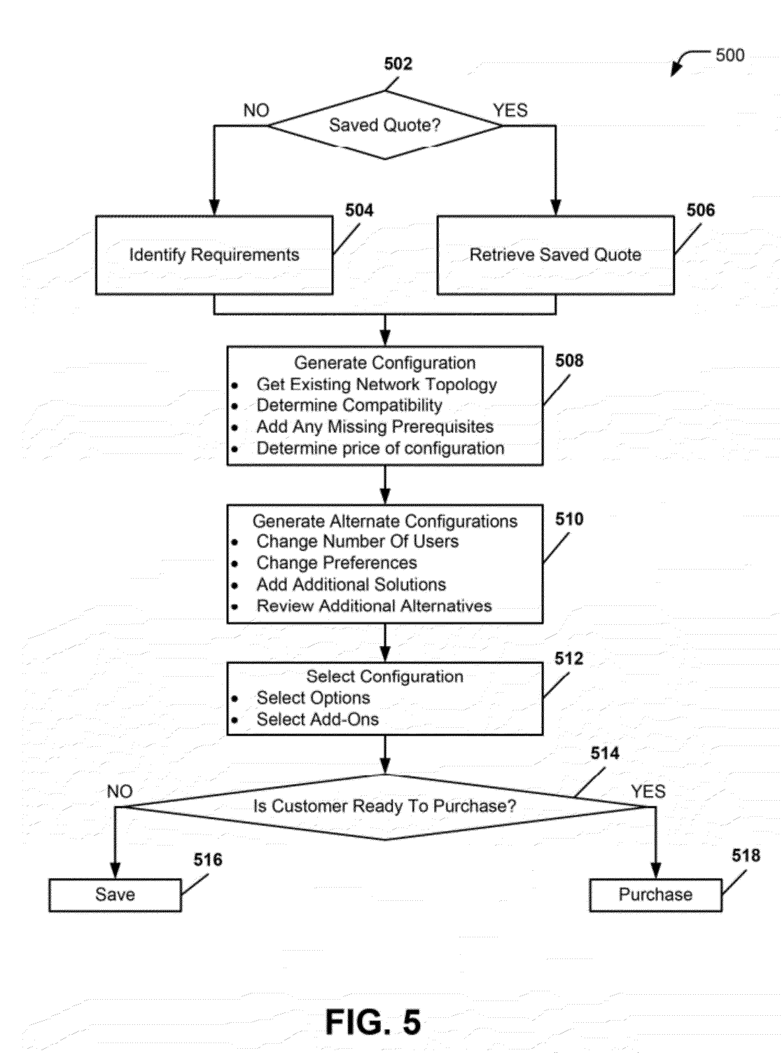

Referring to FIG. 5, a flow diagram of a third method to generate configuration options is depicted and generally designated 500. The method 500 may be performed by a configuration server, such as the configuration server 102 of FIG. 1.

The method begins when the customer is asked whether they have a saved quote, at 502. When the customer does not have a saved quote, the configuration server may identify the requirements of the customer, at 504. When the customer has a saved quote, the configuration server may retrieve the saved quote, at 506.

Advancing to 508, a configuration may be generated. For example, the configuration server may determine an existing network topology of the customer. The configuration server may determine a compatibility of a solution to the existing network topology and add any missing prerequisites. The configuration server may determine a price for the configuration.

Moving to 510, the configuration server may generate alternate configurations that are based on changing the number of users, changing the customer preferences, adding additional solutions, and reviewing additional alternatives. For example, the additional solutions may include providing additional software solutions, such as complimentary solutions to the solution selected by the customer. To illustrate, the customer may select a point-of-sale solution for a retail store. The additional solutions may include an inventory management system, an employee time card system, a payroll system, and an accounting system. The configuration server may provide additional alternatives to the generated configurations that may be alternate configurations that do not meet all of the customer requirements and the customer preferences. For example, the additional alternatives may include solutions that customers with similar requirements have selected. In this way, the configuration server may suggest alternatives that the customer had not considered.

Advancing to 512, a particular configuration of the alternate configurations may be selected by the customer. The customer may prompted to select options and add-ons, such as anti-virus software, productivity software, and other available options and add-ons. Proceeding to 514, the configuration server may ask the customer whether the customer is ready to purchase the selected configuration. When the customer is ready to purchase the selected configuration, a process to purchase the selected configuration may be initiated, at 518. When the customer is not ready to purchase the selected configuration, the selected configuration may be saved at 516.

Thus, a customer may create a quote and save the quote for subsequent retrieval. The quote may include various configurations and alternatives. The quote may include options and add-ons that the customer has selected.

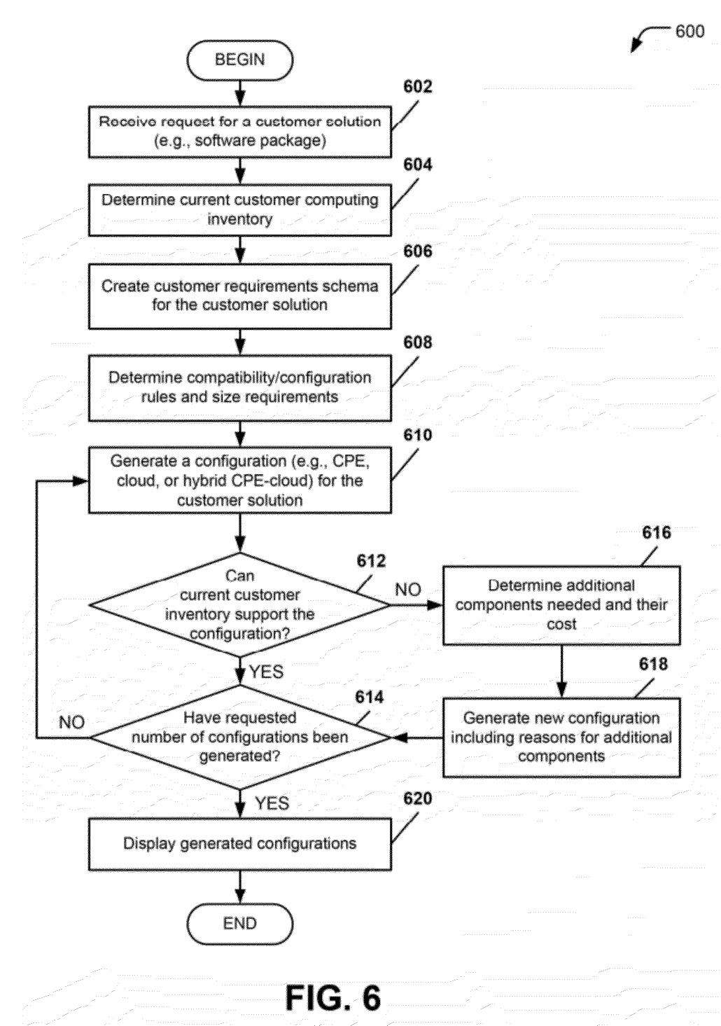

Referring to FIG. 6, a flow diagram of a fourth method to generate configuration options is depicted and generally designated 600. The method 600 may be performed by the configuration server 102 of FIG. 1.

The method begins at 602, when a request is received for a customer solution. For example, the customer solution may be a particular software package that provides a particular solution to a customer, such as a point of sale solution or an inventory control solution for a retail store. Moving to 604, a current customer computing inventory is determined. For example, when the customer is a new customer, the configuration server may prompt the customer to enter their current computing inventory. When the customer is not a new customer, the configuration server may retrieve the current customer computing inventory from a customer inventory database server, such as the customer inventory database server 106 of FIG. 1.

Proceeding to 606, a customer requirement schema is created for the customer solution. Advancing to 608, compatibility and configuration rules and size requirements are determined for the customer solution. For example, the configuration server may determine whether the current customer computing inventory includes the computing resources required to deploy the customer solution. Moving to 610, a configuration is generated for the customer solution. For example, the configuration may be a customer premises equipment based solution, a cloud computing based solution, or a hybrid CPE-cloud computing solution.

Advancing to 612, a determination is made whether the current customer inventory can support the configuration. When the customer inventory cannot support the configuration, the method proceeds to 616 where additional components are determined and their associated costs. For example, the current customer inventory may require additional components to support the configuration and those additional components and their associated costs may be added to the solution. As another example, when the current customer inventory is incapable of supporting the configuration, the additional components may be used to replace at least a portion of the current customer inventory. Advancing to 618, a new configuration that includes the reasons for the additional components may be generated. When the current customer inventory can support the configuration, at 612, the method proceeds to 614, where a determination is made whether the requested number of configurations has been generated. When the requested number of configurations has not been generated, the method proceeds to 610 to generate another configuration. When the requested number of configurations has been generated, at 614, the generated configurations are displayed, at 620, and the method ends.

Thus, when a customer desires to deploy a particular software solution, a configuration server can generate various configurations based on the current customer computing inventory and the compatibility and configuration rules of the software solution. The configuration server may determine whether any components of the current customer computing inventory should be replaced or upgraded to support the software solution.

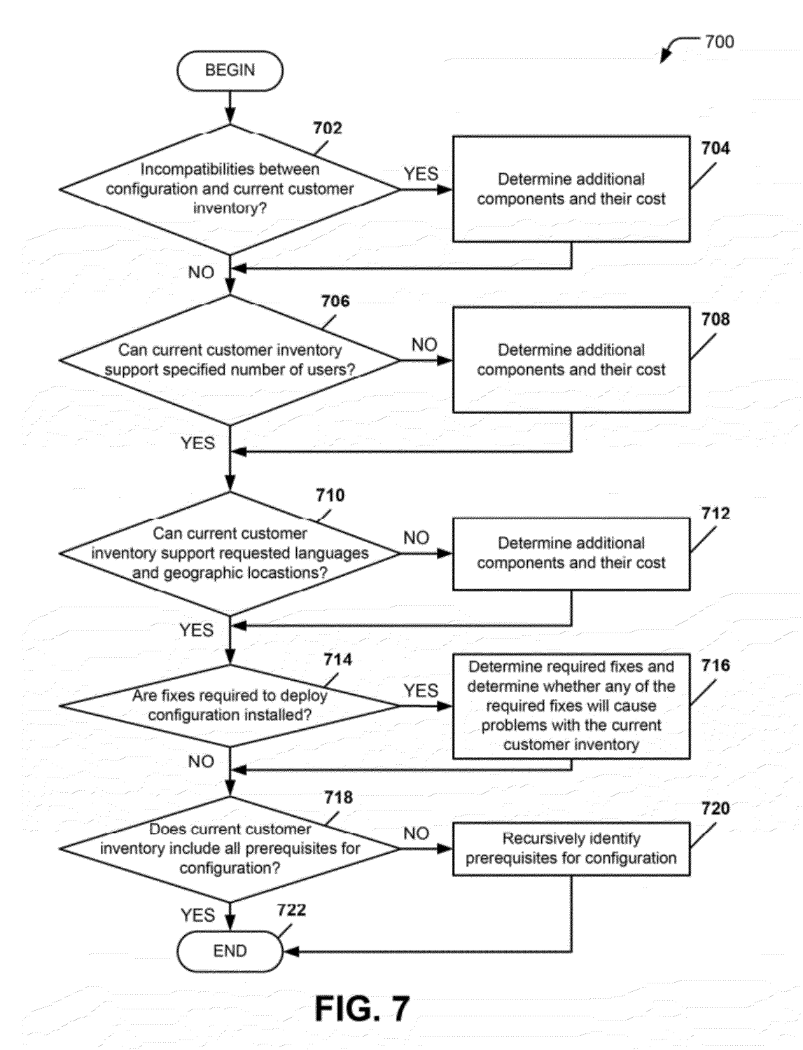

Referring to FIG. 7, a flow diagram of a fifth method to generate configuration options is depicted and generally designated 700. The method 700 may be performed by the configuration server 102 of FIG. 1. The method 700 illustrates the method involved in determining whether a current customer inventory can support a proposed solution, such as in 612 of FIG. 6.

The method begins at 702 when a determination is made whether there are incompatibilities between a particular configuration and the current customer inventory. When there are incompatibilities between a particular configuration and the current customer inventory, the configuration server may determine additional components to support the particular configuration, at 704. For example, a particular configuration may require a particular type of hardware component or software component that is not currently in the current customer inventory.

Moving to 706, a determination is made whether the current customer inventory can support the specified number of users. When the current customer inventory cannot support the specified number of users, the configuration server may determine additional components to support the particular configuration, at 708. For example, the customer may indicate that fifty people will be using the software solution at any given time. The current customer inventory may be capable of supporting thirty people at any given time. The configuration server may determine the additional hardware and/or software components need to support fifty people.

Proceeding to 710, a determination is made whether the current customer inventory can support the requested languages and geographic locations. When the current customer inventory cannot support the requested languages and geographic locations, the configuration server may determine additional components to support the particular configuration, at 712. For example, when the customer desires to have a user interface presented in Spanish and French, the configuration server may determine that a language pack add-on software component may be an additional component. As another example, when the customer desires that a particular geographic location access a software solution and the software solution executes on hardware that may not be exported to that particular geographic location, the configuration server may determine that the particular geographic location be given access to the software solution via a cloud computing configuration.

Advancing to 714, a determination is made whether a prerequisite to deploying the software solution includes one or more fixes (e.g., updates). When the current customer inventory does not include the one or more prerequisite fixes, the configuration server may determine the fixes that are required. The configuration server may also determine whether any of the required fixes will cause a problem for the current customer inventory. For example, a particular software solution may have a prerequisite of a particular software, firmware, or hardware fix and the customer may not have that fix installed. However, that particular fix may be incompatible with a software solution that the customer has currently deployed. The configuration server may determine additional components need to enable the required fixes to be deployed. To illustrate, the customer may currently have software solution A deployed on platform B. The customer may wish to deploy software solution C. The software solution C may require a fix D, but deploying fix D for platform B may cause software solution A to stop working. The configuration server may determine that a new platform E should be deployed and the software solution A moved to execute on platform E and fix D should be installed on platform B to enable software solution C to execute on platform B.

Continuing to 718, a determination is made whether the current customer inventory includes all the prerequisites for the configuration. When the current customer inventory does not include all the prerequisites for the configuration, the configuration server may recursively identify the prerequisites for the configuration, and the method ends.

Thus, for each configuration that the configuration server generates, the configuration server may determine any additional components needed to deploy the configuration.

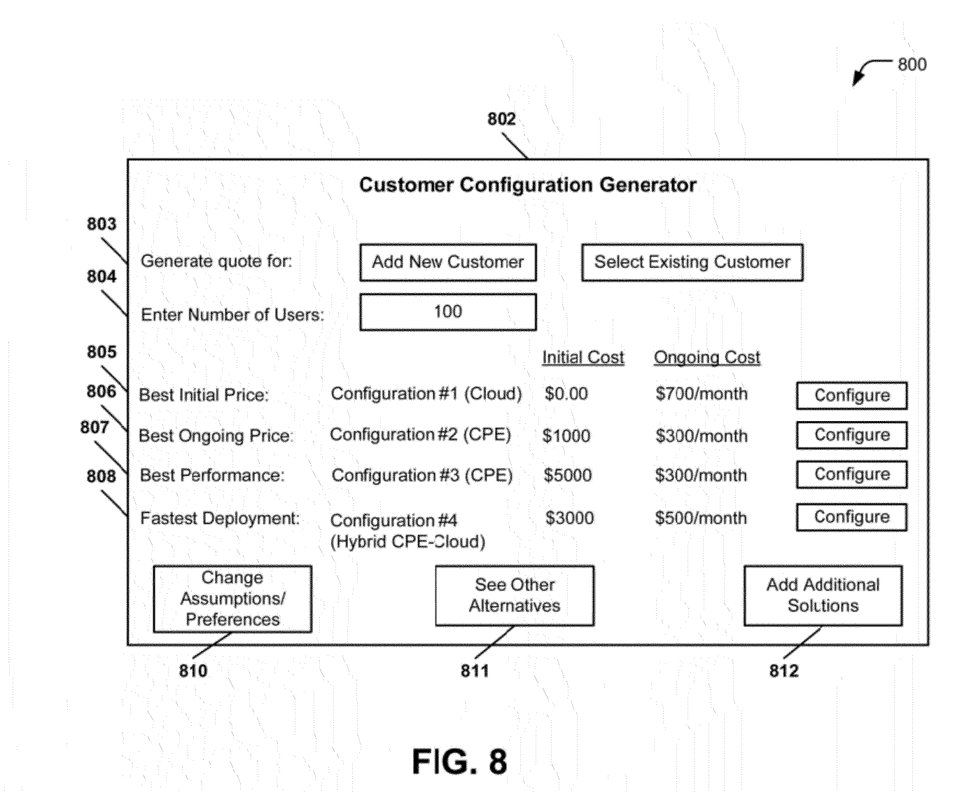

Referring to FIG. 8, a block diagram of a first embodiment of a graphical user interface (GUI) to generate configuration options is depicted and generally designated 800. The GUI 800 may be presented by the configuration server 102 of FIG. 1. The GUI 800 includes a screen 802, lines 803-808, and screen selections 810-812.

The line 803 enables a customer (or a reseller) to add the customer when the customer is a new customer and to retrieve the customer name when the customer is not a new customer. When the customer is an existing customer, a current computing inventory of the customer may be retrieved from a customer inventory database server. When the customer is a new customer, the customer (or reseller) may be prompted to enter the current computing inventory of the customer for storage at the customer inventory database server.

The line 804 enables the customer (or reseller) to enter the number of users that will be using a particular software solution. The lines 805-808 detail different configurations selected for display based preferences of the customer. For example, the customer may have requested a preference to view those configurations with a best initial price, a best ongoing price, a best performance, and a fastest deployment. Each of the configurations listed in the lines 805-808 may be one of a CPE-based configuration, a cloud computing-based configuration, and a hybrid CPE-cloud based configuration. Each of the lines 805-808 may have a “configure” selection to enable the customer to further configure each of the configurations listed in the lines 805-808.

The selection 810 may enable the customer to modify various assumptions and preferences. For example, the selection 810 may enable the customer to modify basic assumptions (e.g., defaults) that are used when generating the configurations.

The selection 811 may enable the customer to view other alternatives, such as alternative configurations. The configurations that are displayed in the GUI 800 may be based on the customer preferences. The selection 811 may enable the customer to see alternative configurations that were not displayed because they did not meet the specified preferences. For example, the alternative configurations may include a lowest cost over three years, a lowest cost over five years, and a lowest cost over ten years.

The selection 812 may enable the customer to add additional solutions and then generate configuration options based on the additional solutions. For example, the customer may have initially selected a point of sale solution and viewed configuration options associated with the point of sale solution. The customer may add an inventory management solution using the selection 812 to enable the configuration server to display configuration options that support both the point of sale solution and the inventory management solution. Thus, the GUI 800 may enable the customer to view and modify various configuration options.

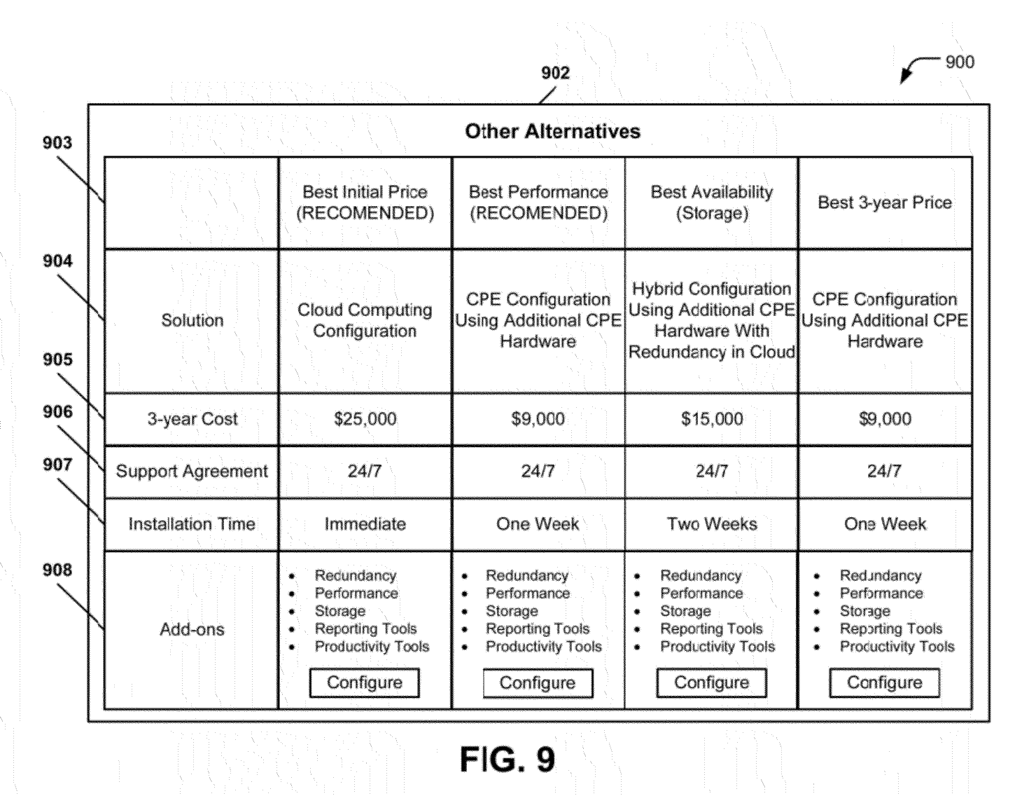

Referring to FIG. 9, a block diagram of a second embodiment of a GUI to generate configuration options is depicted and generally designated 900. The GUI 900 may be presented by the configuration server 102 of FIG. 1. The GUI 900 includes a screen 902 and lines 903-908. The GUI 900 may be displayed when the customer selects selection 811 of FIG. 8 to view alternative configurations.

The line 903 may identify the alternate configuration options. The line 904 may indicate for each configuration option whether the configuration option is a CPE-based configuration, a cloud-based configuration, or a hybrid CPE-cloud configuration. The line 905 may identify a particular cost to the customer, such as an initial cost, an ongoing (e.g., monthly or yearly) cost, or a total cost over a specified time period. The line 906 may indicate the type of support agreement that is included with each configuration option.

The line 907 may identify an installation time associated with each configuration option, i.e., how long it would take to install each configuration option. The line 908 may enable the customer to add various add-ons, such as redundancy, performance, storage, reporting, tools, and productivity tools and then view configuration options associated with adding the add-ons to the basic configuration. For example, the customer may determine that adding a particular add-on to the configuration may result in additional computing resources and additional cost being added to the configuration. The customer may decide that the customer cannot afford the added cost and then remove the add-on. As another example, the customer may determine that adding a particular add-on does not result in additional computing resources and additional cost being added to the configuration. In this case, the customer may decide to purchase the configuration including the add-on. Thus, a customer can view alternative configuration options, modify the configuration options, and view the result of modifying the configuration options via the GUI 900.

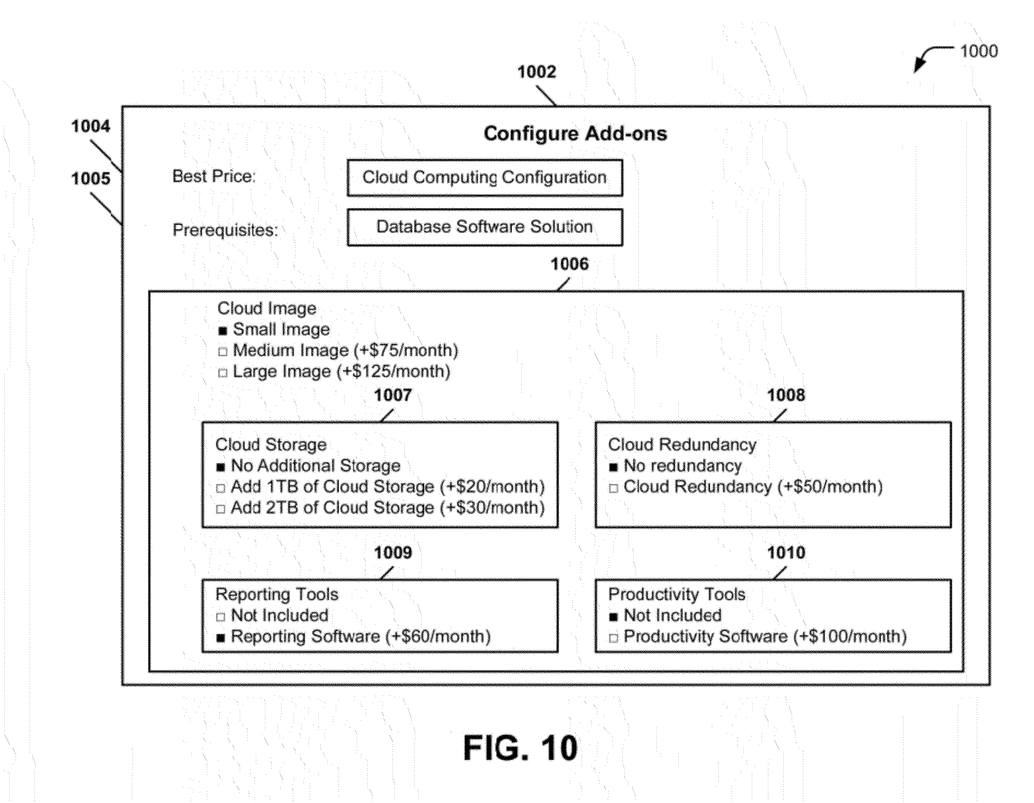

Referring to FIG. 10, a block diagram of a third embodiment of a GUI to generate configuration options is depicted and generally designated 1000. The GUI 1000 may be presented by the configuration server 102 of FIG. 1. The GUI 1000 may be displayed when the customer selects a configure selection of line 908 of FIG. 9 to configure add-ons. The GUI 1000 includes lines 1004-1005 and windows 1006-1010.

The line 1004 identifies whether a configuration is a CPE-based configuration, a cloud-based configuration, or a hybrid CPE-cloud based configuration.

The window 1006 enables the customer to configure various add-ons, such as the size of the image. The window 1007 enables the customer to select a storage add-on and the associated cost. The window 1008 enables the customer to select a redundancy add-on and the associated cost. The window 1009 enables the customer to select whether reporting tools are included in the configuration option and to view their associated costs. The window 1010 enables the customer to select whether productivity tools are included in the configuration option and to view their associated costs. Thu, the GUI 1000 enables a customer to configure various add-ons and see the associated costs associated with those configurations.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and features as defined by the following claims.

What is claimed is:

1. A computer-implemented method, comprising:
receiving, at a configuration server, requirements data identifying computing requirements of a customer;
receiving, at the configuration server, inventory information descriptive of a computing inventory of the customer;
accessing compatibility rules that specify hardware and software to enable particular computing requirements;
generating a plurality of configuration options to implement the computing requirements of the customer based on at least one of the requirements data, the computing inventory, and the compatibility rules, the plurality of configuration options including at least one customer premises equipment (CPE)-based configuration, at least one cloud computing-based configuration, and at least one hybrid CPE-cloud computing-based configuration;
comparing the plurality of configuration options based on customer preferences; and
providing at least one configuration recommendation based on comparing the plurality of configuration options.

2. The computer-implemented method of claim 1, further comprising:
determining whether the customer is a new customer; and
prompting the new customer to provide the inventory information.

3. The computer-implemented method of claim 2, further comprising retrieving the inventory information from an inventory database server when the customer is not a new customer.

4. The computer-implemented method of claim 1, wherein the inventory information identifies hardware and software associated with the customer.

5. The computer-implemented method of claim 1, wherein the inventory information includes an available processing capacity, an available memory capacity, an available disk storage capacity, an available physical space, and geographic locations of the hardware associated with the customer.

6. The computer-implemented method of claim 1, wherein determining the plurality of configuration options to implement the computing requirements of the customer further comprises determining, based on the compatibility rules, prerequisites data identifying additional computing resources to implement the computing requirements of the customer.

7. The computer-implemented method of claim 1, further comprising:
receiving modified requirements data identifying modified computing requirements of the customer;
determining a second plurality of configuration options to implement the modified customer requirements based on the inventory information and the compatibility rules, wherein the second plurality of configuration options include a second CPE-based configuration, a second cloud computing-based configuration, and a second hybrid CPE-cloud computing-based configuration;
comparing the second plurality of configuration options based on the customer preferences; and
providing a second configuration recommendation based on comparing the second plurality of configuration options.

8. The computer-implemented method of claim 1, wherein the computing requirements of the customer include a number of users requirement and a user interface language requirement.

9. The computer-implemented method of claim 1, further comprising:
determining a cost for each of the plurality of configuration options; and
providing a lowest priced configuration recommendation.

10. A computer program product comprising a non-transitory computer usable medium having computer usable program code embodied therewith, the computer usable program code executable by a processor to:
receive requirements data identifying computing requirements of a customer;
receive inventory information descriptive of a computing inventory of the customer;
access compatibility rules that specify hardware and software to enable particular computing requirements;
determine a plurality of configuration options to implement the computing requirements of the customer based on at least one of the requirements data, the computing inventory, and the compatibility rules, the plurality of configuration options including at least one customer premises equipment (CPE)-based configuration, at least one cloud computing-based configuration, and at least one hybrid CPE-cloud computing-based configuration;
compare the plurality of configuration options based on customer preferences; and
provide at least one configuration recommendation based on comparing the plurality of configuration options.

11. The computer program product of claim 10, wherein the inventory information identifies hardware and software associated with the customer.

12. The computer program product of claim 10, wherein the inventory information includes an available processing capacity, an available memory capacity, an available disk storage capacity, an available physical space, and geographic locations of the hardware associated with the customer.

13. The computer program product of claim 10, wherein the computer usable program code is further executable by the processor to determine, based on the compatibility rules, prerequisites data identifying additional computing resources to implement the computing requirements of the customer.

14. The computer program product of claim 10, wherein the computer usable program code is further executable by the processor to:
receive modified requirements data identifying modified computing requirements of the customer;
determine a second plurality of configuration options to implement the modified customer requirements based on the inventory information and the compatibility rules, wherein the second plurality of configuration options include a second CPE-based configuration, a second cloud computing-based configuration, and a second hybrid CPE-cloud computing-based configuration;
compare the second plurality of configuration options based on the customer preferences; and
provide a second configuration recommendation based on comparing the second plurality of configuration options.

15. The computer program product of claim 10, wherein the computer usable program code is further executable by the processor to:
determine a price for each of the plurality of configuration options; and
provide a lowest priced configuration recommendation.

16. A configuration server, comprising:
a processor; and
a non-transitory memory having computer usable program code embodied therewith, the computer usable program code executable by the processor to:
receive requirements data identifying computing requirements of a customer;
receive inventory information descriptive of a computing inventory of the customer;
access compatibility rules that specify hardware and software to enable particular computing requirements;
determine a plurality of configuration options to implement the computing requirements of the customer based on at least one of the requirements data, the computing inventory, and the compatibility rules, the plurality of configuration options including at least one customer premises equipment (CPE)-based configuration, at least one cloud computing-based configuration, and at least one hybrid CPE-cloud computing-based configuration;
compare the plurality of configuration options based on customer preferences; and
provide at least one configuration recommendation based on comparing the plurality of configuration options.

17. The configuration server of claim 16, wherein the inventory information includes an available processing capacity, an available memory capacity, an available disk storage capacity, an available physical space, and geographic locations of the hardware associated with the customer.

18. The configuration server of claim 16, wherein the computer usable program code is further executable by the processor to determine, based on the compatibility rules, prerequisites data identifying additional computing resources to implement the computing requirements of the customer.

19. The configuration server of claim 16, wherein the computer usable program code is further executable by the processor to:
receive modified requirements data identifying modified computing requirements of the customer;
determine a second plurality of configuration options to implement the modified customer requirements based on the inventory information and the compatibility rules, wherein the second plurality of configuration options include a second CPE-based configuration, a second cloud computing-based configuration, and a second hybrid CPE-cloud computing-based configuration;
compare the second plurality of configuration options based on the customer preferences; and
provide a second configuration recommendation based on comparing the second plurality of configuration options.

20. The configuration server of claim 16, wherein the computer usable program code is further executable by the processor to:
determine a price for each of the plurality of configuration options; and
provide a lowest priced configuration recommendation.
